(19) United States
(12) Patent Application Publication
(10) Pub. No.: US 2010/0105274 A1
(43) Pub. Date: Apr. 29, 2010

(54) Polypropylene Fibers and Spunbond Nonwoven with Improved Properties

(75) Inventors: Hugues Haubruge, Walhain (BE); Guillaume Pavy, Bruxelles (BE)

Correspondence Address: FINA TECHNOLOGY INC, PO BOX 674412, HOUSTON, TX, 77267-4412, US

(73) Assignee: TOTAL PETROCHEMICALS RESEARCH FELUY, Seneffe (BE)

(21) Appl. No.: 12/526,354

(22) PCT Filed: Feb. 25, 2008
(86) PCT No.: PCT/EP08/52261

§ 371 Date: Aug. 7, 2009

(30) Foreign Application Priority Data
Feb. 28, 2007 (EP) 07103192.6

(51) Int. Cl. D04H 3/16; D01D 5/12; C08F 110/06

(52) U.S. Cl. 442/401; 264/210.8; 526/351

(57) ABSTRACT

The present invention relates to a process for the production of polypropylene fibers and polypropylene spunbond nonwoven comprising a degradation step, wherein the melt flow of the polypropylene is increased, and a fiber or filament extrusion step. The present invention also relates to the fibers and nonwoven produced with said process and to composites and laminates comprising said fibers and nonwoven.

### FIELD OF THE INVENTION

The present invention relates to a process for the production of polypropylene fibers and polypropylene spunbond nonwoven with improved properties. The present invention also relates to the fibers and nonwoven made with said process. Additionally it relates to composites and laminates comprising such fibers and nonwoven.

### THE TECHNICAL PROBLEM AND THE PRIOR ART

Polypropylene has become one of the most widely used polymers in fibers and nonwoven. Due to its versatility and the good mechanical and chemical properties polypropylene is well suited to fulfill requirements in many different applications. Polypropylene fibers and nonwoven are for example used in the construction and agricultural industries, sanitary and medical articles, carpets, textiles.

The polypropylenes used for fibers and nonwoven have a melt flow that—depending upon the production method, final use etc.—can be in the range from 5 dg/min for very strong high-tenacity fibers up to several thousand dg/min for meltblown nonwoven. Typically, the polypropylenes used in fiber extrusion have a melt flow in the range from 5 dg/min to about 40 dg/min. The polypropylenes typically used for spunbond nonwoven have a melt flow index in the range from 25 dg/min to 40 dg/min and are additionally characterized by a narrow molecular weight distribution (Polypropylene Handbook, ed. Nello Pasquini, 2^{nd} edition, Hanser, 2005, p. 397).

Polypropylenes are generally produced by the polymerization of propylene and one or more optional comonomers in presence of a Ziegler-Natta catalyst, i.e. transition metal coordination catalysts, specifically titanium halide containing catalysts. These catalysts in general also contain internal electron donors, such as phthalates, diethers, or succinates. The polypropylenes produced by Ziegler-Natta catalysts can be directly used without modification for the production of fibers. However, in order to give good processability and nonwoven properties in spunbond nonwoven the molecular weight distribution needs to be narrowed, which can be done either thermally or chemically by post-reactor degradation.

Research Disclosure RD 36347, for example, discloses the use of a polypropylene degraded from a starting melt flow of 1 dg/min to a final melt flow of 20 dg/min in the production of a spunbond nonwoven. The degraded polypropylene has a molecular weight distribution in the range from 2.1 to 2.6.

Whilst not wishing to be bound by theory it is believed that under the processing conditions used in the production of a spunbond nonwoven, the narrowing of the molecular weight distribution leads to a lower melt elasticity, which in turn results in a reduction of die swell and in lower resistance to fiber drawing. Thus, the stability of the spinning process as well as the maximum spinning speeds are increased. Additionally, a polypropylene of narrower molecular weight distribution will be better able to retain orientation and better mechanical properties of the nonwoven.

Despite the progress in mechanical properties over the recent years, there remains a constant demand for further improvement so as to allow for further downgauging and further increases in processability.

It is therefore an objective of the present invention to further improve the processability of Ziegler-Natta polypropylene in fiber spinning and in the production of spunbond nonwoven while keeping or improving the mechanical properties of the fibers and spunbond nonwoven made from Ziegler-Natta polypropylene.

### BRIEF DESCRIPTION OF THE INVENTION

We have now discovered a process for producing polypropylene fibers or spunbond nonwoven with improved processability while keeping or improving the properties of the fibers and nonwoven made from Ziegler-Natta polypropylene.

Thus, the present invention relates to a process for the production of polypropylene fibers or polypropylene spunbond nonwoven, said process comprising the steps of
(a) thermally or chemically degrading a Ziegler-Natta polypropylene from a first melt flow MFI₁ (ISO 1133, 230° C., 2.16 kg) to a second melt flow MFI₂ such that the second melt flow MFI₂ (ISO 1133, 230° C., 2.16 kg) is at least 50 dg/min and at most 300 dg/min and such that the degradation ratio MFI₁/MFI₂ is at least 0.10 and at most 0.8,
(b) extruding the polypropylene obtained in step (a) from a number of fine, usually circular, capillaries of a spinneret, thus obtaining filaments, and
(c) rapidly reducing the diameter of the filaments extruded in the previous step to a final diameter.

Additionally, the present invention relates to fibers and nonwoven produced in accordance with the present process.

Further, the present invention relates to composites and laminates comprising the fibers and nonwoven of the present invention.

### DETAILED DESCRIPTION OF THE INVENTION

For the present invention the polypropylene fibers are produced by methods well known to the skilled person. Molten polypropylene is extruded through a number of fine capillaries of a spinneret. The still molten fibers are simultaneously cooled by air and drawn to an intermediate diameter. In a further optional step the fibers can be drawn over heated rolls or in a heated oven to further reduce the intermediate diameter to a final diameter and increase the tenacity of the fibers. If no further drawing step is performed the intermediate diameter is the final diameter.

For the present invention the polypropylene nonwoven are produced by the spunbonding process. Polypropylene is molten in an extruder and extruded from a number of fine, usually circular, capillaries of a spinneret, thus obtaining filaments. The filament formation step can either be accomplished by using one single spinneret with a large number of holes, generally several thousand, or by using several smaller spinnerets with a correspondingly smaller number of holes per spinneret. After exiting from the spinneret the still molten filaments are quenched by a current of cold air. The diameter of the filaments in then rapidly reduced to a final diameter by a stream of high-pressure air. Air velocities in the drawdown step can be of several thousand meters per minute.

After drawdown the filaments are collected on a support, for example a wire mesh belt, thus creating a first fabric, which may then be passed through compaction rolls and finally passes through a bonding step. Bonding of the fabric may be accomplished by thermobonding, hydroentanglement, needlepunching, or chemical bonding.

The spunbond nonwoven layers of the present invention may be used to form composites of nonwoven layers or laminates with film. Said composite comprises a spunbond nonwoven layer (S) according to the present invention and a melt blown nonwoven layer (M). The composites can for example be of the SS, SSS, SMS, SMMSS or any other type. Said laminate comprises a spunbond nonwoven layer (S) according to the present invention and a film layer (F) The laminates can be of the SF, SFS or any other type. The film of said laminate may be a breathable barrier film, thus resulting in a laminate with breathable properties.

The polypropylenes used in the present invention can be either homopolymers or random copolymers of propylene with one or more comonomers, which can be ethylene or a C₄-C₂₀ olefin. The preferred random copolymer is a copolymer of propylene and ethylene. The random copolymers of the present invention comprise at least 0.1 wt %, preferably at least 0.2 wt % and most preferably at least 0.5 wt % of comonomer. They comprise at most 6 wt %, more preferably at most 5 wt % and most preferably at most 4 wt % of comonomer. The most preferred polypropylene is a polypropylene homopolymer.

The polypropylenes of the present invention are preferably predominantly isotactic polypropylenes. This means that characterized by high isotacticity, for which the content of mmmm pentads is a measure. The content of mmmm pentads is at least 95.0%, preferably at least 96.0%, more preferably at least 97.0% and most preferably at least 98.0%. The isotacticity is determined by NMR analysis according to the method described by G. J. Ray et al. in Macromolecules, vol. 10, n° 4, 1977, p. 773-778.

The polypropylenes used in the present invention can be produced by polymerizing propylene and one or more optional comonomers in the presence of a Ziegler-Natta catalyst system, which is well-known to the skilled person. A Ziegler-Natta catalyst system comprises a titanium compound having at least one titanium-halogen bond and an internal electron donor, both on a suitable support (for example on a magnesium halide in active form), an organoaluminium compound (such as an aluminium trialkyl), and an optional external donor (such as a silane or a diether compound).

The polymerization of propylene and one or more optional comonomers can be carried out in a slurry, bulk or gas phase process. In a slurry process the polymerization is carried out in a diluent, such as an inert hydrocarbon. In a bulk process the polymerization is carried out in liquid propylene as reactor medium.

For the present invention, the polypropylene obtained using a Ziegler-Natta catalyst is either thermally or chemically degraded. Preferably it is chemically degraded (visbroken). For chemical degradation the molten polypropylene is brought into intimate contact with a peroxide (for example 2,5-dimethylhexane-2,5-di-tertbutylperoxide) leading to the generation of radicals which in turn lead to a breakdown of the polymer chains. Thus, the melt flow index of the polypropylene increases. As a consequence of the longer polymeric chains being preferentially attacked by the radicals for statistical reasons, the molecular weight distribution narrows. Visbreaking of polypropylene is usually carried out at temperatures in the range from 200° C. to 250° C. It can for example be done in the extruder in the granulation step of a polypropylene manufacturing plant.

The extent to which a polypropylene has been degraded can be described with the degradation ratio, which is the ratio between a first melt flow index (MHO before degradation and a second melt flow index (MFI₂) after degradation. The polypropylenes used in the present invention have a degradation ratio MFI₁/MFI₂ of at least 0.1, preferably at least 0.12, more preferably at least 0.14, even more preferably of at least 0.16, still even more preferably of at least 0.18, and most preferably at least 0.20. The polypropylenes used in the present invention have a degradation ratio MFI₁/MFI₂ of at most 0.8, more preferably of at most 0.7, even more preferably of at most 0.6, and most preferably of at most 0.5.

The second melt flow index MFI₂ of the polypropylenes used in the present invention is at least 50 dg/min, preferably at least 55 dg/min, and most preferably at least 60 dg/min. The second melt flow index MFI₂ of the polypropylenes used in the present invention is at most 300 dg/min, preferably at most 200 dg/min, more preferably at most 150 dg/min and most preferably at most 100 dg/min.

The polypropylenes of the present invention may also contain additives such as, by way of example, antioxidants, light stabilizers, acid scavengers, lubricants, antistatic additives, and colorants.

The polypropylenes of the present invention are characterized by easier processability than the polypropylenes of the prior art. This allows for example to reduce the extruder temperatures, which can lead to energy savings and/or increase the throughput of an existing fiber or nonwoven production line. Additionally the polypropylenes of the present invention can be more easily drawn when molten thus permitting higher drawdown ratios. This in turn leads to finer fibers. When used for making a nonwoven, either from fibers or directly by spunbonding, the resulting nonwoven will have higher web coverage, improved barrier properties, and better consistency.

The higher melt flow index of fibers and nonwoven made according to the present invention allows a reduction in the temperature, at which thermal bonding of the nonwoven is performed. In consequence, less energy needs to be put into the preformed nonwoven so that the line speeds of for example a thermal bonding line or a spunbond line can be increased.

A further advantage of the present invention is that it allows the production of a wider range of fibers and nonwoven on existing production equipment. In particular, it allows to produce finer fibers and nonwoven with finer filaments without changes to the equipment.

When producing fibers and nonwoven according to the present invention it has surprisingly been found that the higher melt flow index of the polypropylenes of the present invention does not lead to a loss in mechanical properties on fibers and nonwoven as compared to fibers and nonwoven made with conventional polypropylenes, which have a lower melt flow index.

The polypropylene fibers of the present invention can be used in carpets, woven textiles, and nonwovens.

The polypropylene spunbond nonwoven of the present invention as well as composites or laminates comprising it can be used for hygiene and sanitary products, such as for example diapers, feminine hygiene products and incontinence products, products for construction and agricultural applications, medical drapes and gowns, protective wear, lab coats etc.

### Examples

Test Methods

The melt flow index was measured according to norm ISO 1133, condition L, using a weight of 2.16 kg and a temperature of 230° C.

The molecular weight of the samples is measured using gel permeation chromatography (GPC). The samples are dissolved in 1,2,4-trichlorobenzene. The resulting solution is injected into a gel permeation chromatograph and analyzed under conditions well-known in the polymer industry.

Fiber titers were measured on a Zweigle vibroscope S151/2 in accordance with norm ISO 1973:1995.

Fiber tenacity and elongation were measured on a Lenzing Vibrodyn according to norm ISO 5079:1995 with a testing speed of 10 mm/min.

Tensile strength and elongation of the nonwoven were measured according to ISO 9073-3:1989.

Polypropylenes

Fibers and nonwoven were produced using a polypropylene homopolymer PP1 of melt flow 60 dg/min in accordance with the present invention, and a polypropylene homopolymer PP2 of the prior art as comparative product. PP1 and PP2 were additivated with standard antioxidants and acid scavengers. Properties of PP1 and PP2 are given in table 1.

TABLE 1

| | | | PP2 |
|---|---|---|---|
| | | PP1 | Comp. ex. |
| Degradation ratio MFI₁/MFI₂ | | 0.2 | 0.08 |
| Final MFI | dg/min | 60 | 25 |
| Mₙ | kDa | 33 | 46 |
| M_{w} | kDa | 152 | 189 |
| M_{z} | kDa | 431 | 452 |
| MWD = M_{w}/Mₙ | | 4.6 | 4.1 |

Fiber Spinning

Polypropylenes PP1 and PP2 were spun into fibers on a Busschaert pilot line equipped with two circular dies of 112 holes each of a diameter of 0.5 mm. Melt temperature was kept at 250° C. Throughput per hole was kept constant at 0.5 g/hole/min. No additional drawing step was performed.

The properties of the fibers are shown in table 2. The results show that fibers made with PP1 have almost the same properties as the fibers made with PP2, despite the higher melt flow index of PP1.

TABLE 2

| | | | PP2 |
|---|---|---|---|
| | | PP1 | Comp. ex. |
| Fiber titer | dtex | 3.4 | 3.0 |
| Tenacity at Fₘₐₓ | cN/tex | 19.2 | 19.5 |
| Elongation at break | % | 219 | 222 |

Spunbond Nonwoven

Polypropylenes PP1 and PP2 were used to produce spunbond nonwoven on a 1 m wide Reicofil 4 line with a single beam having about 6800 holes per meter length, the holes having a diameter of 0.6 mm. Throughput per hole was set at 0.41 g/hole/min. Line speed was kept at 225 m/min. The nonwoven had a fabric weight of 12 g/m². The nonwoven were thermally bonded using an embossed roll. Further processing conditions are given in table 3. The bonding roll temperature reported in table 3 is the bonding temperature at which the highest values for elongation were obtained. Properties of the nonwoven obtained under these conditions are shown in table 4.

TABLE 3

| | | | PP2 |
|---|---|---|---|
| | | PP1 | Comp. ex. |
| Extruder temperature | ° C. | 240 | 250 |
| Melt temperature at the die | ° C. | 239 | 251-257 |
| Cabin pressure | Pa | 5500 | 3500 |
| Nip pressure | N/mm | 60 | 60 |
| Calender temperature (set point) | ° C. | 143 | 149 |
| for max. elongation | | | |

TABLE 4

| | | | PP2 |
|---|---|---|---|
| | | PP1 | Comp. ex. |
| Filament titer | den | 1.24 | 1.67 |
| Tensile strength @ max MD | N/5 cm | 28.5 | 28.9 |
| Tensile strength @ max CD | N/5 cm | 16.5 | 16.2 |
| Elongation MD | % | 80 | 71 |
| Elongation CD | % | 85 | 72 |

The results clearly demonstrate the advantages of the present invention:
Due to the higher melt flow index PP1 processes more easily. Thus extruder temperatures can be lowered.
The polypropylene of the present invention, PP1, with a lower degradation ratio can be much more easily drawn as is proven by the higher cabin pressure that can be used for PP1.
As a consequence of the better drawability the filaments made with PP1 are much finer. Finer filaments will lead to better web coverage, improved barrier properties and consistency of the nonwoven.
PP1 also showed advantages in the bonding step. The temperature could be reduced by 6° C., thus permitting increased speeds of the spunbond production line, while keeping the mechanical properties of a conventional polypropylene with higher degradation ratio.
Despite the much higher melt flow index the mechanical properties of the nonwoven made with PP1 are on the same level for tensile strength or even better for elongation as compared to a conventional polypropylene with higher degradation ratio.

In summary the results clearly show that the polypropylenes of the present invention, i.e. polypropylene characterized by a lower degradation ratio than what is conventionally used for spunbond nonwoven, gives advantages in processing as well as nonwoven properties.

1-11. (canceled)

12. A process for the production of polypropylene fibers or polypropylene spunbond nonwovens comprising:
thermally or chemically degrading a Ziegler-Natta polypropylene from a first melt flow MFI₁ (ISO 1133, 230° C., 2.16 kg) to a second melt flow MFI₂ (ISO 1133, 230° C., 2.16 kg) such that the second melt flow MFI₂ is at least 50 dg/min and at most 300 dg/min and such that the degradation ratio MFI₁/MFI₂ is at least 0.10 and at most 0.8;
extruding the second melt flow polypropylene to obtain filaments; and
rapidly reducing the diameter of the filaments to a final diameter.

13. The process of claim 12, wherein the second melt flow MFI₂ (ISO 1133, 230° C., 2.16 kg) of the polypropylene is at least 55 dg/min.

14. The process of claim 12, wherein the second melt flow MFI₂ (ISO 1133, 230° C., 2.16 kg) of the polypropylene is at most 200 dg/min.

15. The process of claim 12, wherein the degradation ratio MFI₁/MFI₂ is at least 0.12.

16. The process of claim 12, wherein the degradation ratio MFI₁/MFI₂ is at most 0.7.

17. The process of claim 12, wherein the final diameter of the filaments is at most 2.0 denier per filament.

18. The process of claim 12, wherein the final diameter of the filaments is at least 0.5 denier per filament.

19. The process of claim 12, wherein the polypropylene is a polypropylene homopolymer.

20. Fibers or nonwoven formed from the process of claim 12.

21. Composites and laminates comprising the fibers and nonwovens of claim 20.
